(19) United States
(12) Patent Application Publication
(10) Pub. No.: US 2004/0246213 A1
(43) Pub. Date: Dec. 9, 2004

(54) Display panel having crossover connections effecting dot inversion

(76) Inventors: Thomas Lloyd Credelle, Morgan Hill, CA (US); Matthew Osborne Schlegel, Palo Alto, CA (US)

Correspondence Address: Finnegan, Henderson, Farabow,, Garrett & Dunner, L.L.P., 1300 I Street, N.W., Washington, DC, 20005-3315, US

(21) Appl. No.: 10/455,925

(22) Filed: Jun. 6, 2003

(51) Int. Cl. G09G 3/36

(52) U.S. Cl. 345/87

(57) ABSTRACT

A display is disclosed having crossover connections effecting dot inversion. The display includes a panel substantially comprising a subpixel repeating group, the group having an even number of subpixels across a first direction. The display also includes a driver circuit coupled to the panel providing image data signals to the panel, the signals effecting substantially a dot inversion scheme to the panel. The display also includes a plurality of crossover connections from the driver circuit to the columns of the panel such that same color subpixels across the first direction such that the polarities of the same color subpixels substantially alternate.

### RELATED APPLICATIONS

The present application is related to commonly owned (and filed on even date) United States Patent Applications: (1) U.S. patent application Ser. No. ------ entitled “SYSTEM AND METHOD OF PERFORMING DOT INVERSION WITH STANDARD DRIVERS AND BACKPLANE ON NOVEL DISPLAY PANEL LAYOUTS”; and (2) U.S. patent application Ser. No. ______ entitled “SYSTEM AND METHOD FOR COMPENSATING FOR VISUAL EFFECTS UPON PANELS HAVING FIXED PATTERN NOISE WITH REDUCED QUANTIZATION ERROR”; (3) U.S. patent application Ser. No. ______ entitled “DOT INVERSION ON NOVEL DISPLAY PANEL LAYOUTS WITH EXTRA DRIVERS”; (4) U.S. patent application Ser. No. ______ entitled “LIQUID CRYSTAL DISPLAY BACKPLANE LAYOUTS AND ADDRESSING FOR NON-STANDARD SUBPIXEL ARRANGEMENTS”; and (5) U.S. patent application Ser. No. ______ entitled “IMAGE DEGRADATION CORRECTION IN NOVEL LIQUID CRYSTAL DISPLAYS,” which are hereby incorporated herein by reference.

### BACKGROUND

In commonly owned United States Patent Applications: (1) U.S. patent application Ser. No. 09/916,232 (“the '232 application”), entitled “ARRANGEMENT OF COLOR PIXELS FOR FULL COLOR IMAGING DEVICES WITH SIMPLIFIED ADDRESSING,” filed Jul. 25, 2001; (2) U.S. patent application Ser. No. 10/278,353 (“the '353 application”), entitled “IMPROVEMENTS TO COLOR FLAT PANEL DISPLAY SUB-PIXEL ARRANGEMENTS AND LAYOUTS FOR SUB-PIXEL RENDERING WITH INCREASED MODULATION TRANSFER FUNCTION RESPONSE,” filed Oct. 22, 2002; (3) U.S. patent application Ser. No. 10/278,352 (“the '352 application”), entitled “IMPROVEMENTS TO COLOR FLAT PANEL DISPLAY SUB-PIXEL ARRANGEMENTS AND LAYOUTS FOR SUB-PIXEL RENDERING WITH SPLIT BLUE SUB-PIXELS,” filed Oct. 22, 2002; (4) U.S. patent application Ser. No. 10/243,094 (“the '094 application), entitled “IMPROVED FOUR COLOR ARRANGEMENTS AND EMITTERS FOR SUB-PIXEL RENDERING,” filed Sep. 13, 2002; (5) U.S. patent application Ser. No. 10/278,328 (“the '328 application”), entitled “IMPROVEMENTS TO COLOR FLAT PANEL DISPLAY SUB-PIXEL ARRANGEMENTS AND LAYOUTS WITH REDUCED BLUE LUMINANCE WELL VISIBILITY,” filed Oct. 22, 2002; (6) U.S. patent application Ser. No. 10/278,393 (“the '393 application”), entitled “COLOR DISPLAY HAVING HORIZONTAL SUB-PIXEL ARRANGEMENTS AND LAYOUTS,” filed Oct. 22, 2002; (7) U.S. patent application Ser. No. 01/347,001 (“the '001 application”) entitled “IMPROVED SUB-PIXEL ARRANGEMENTS FOR STRIPED DISPLAYS AND METHODS AND SYSTEMS FOR SUB-PIXEL RENDERING SAME,” filed Jan. 16, 2003, novel sub-pixel arrangements are therein disclosed for improving the cost/performance curves for image display devices and herein incorporated by reference.

These improvements are particularly pronounced when coupled with sub-pixel rendering (SPR) systems and methods further disclosed in those applications and in commonly owned United States Patent Applications: (1) U.S. patent application Ser. No. 10/051,612 (“the '612 application”), entitled “CONVERSION OF RGB PIXEL FORMAT DATA TO PENTILE MATRIX SUB-PIXEL DATA FORMAT,” filed Jan. 16, 2002; (2) U.S. patent application Ser. No. 10/150,355 (“the '355 application”), entitled “METHODS AND SYSTEMS FOR SUB-PIXEL RENDERING WITH GAMMA ADJUSTMENT,” filed May 17, 2002; (3) U.S. patent application Ser. No. 10/215,843 (“the '843 application”), entitled “METHODS AND SYSTEMS FOR SUB-PIXEL RENDERING WITH ADAPTIVE FILTERING,” filed Aug. 8, 2002; (4) U.S. patent application Ser. No. 10/379,767 entitled “SYSTEMS AND METHODS FOR TEMPORAL SUB-PIXEL RENDERING OF IMAGE DATA” filed Mar. 4, 2003; (5) U.S. patent application Ser. No. 10/379,765 entitled “SYSTEMS AND METHODS FOR MOTION ADAPTIVE FILTERING,” filed Mar. 4, 2003; (6) U.S. patent application Ser. No. 10/379,766 entitled “SUB-PIXEL RENDERING SYSTEM AND METHOD FOR IMPROVED DISPLAY VIEWING ANGLES” filed Mar. 4, 2003; (7) U.S. patent application Ser. No. 10/409,413 entitled “IMAGE DATA SET WITH EMBEDDED PRE-SUBPIXEL RENDERED IMAGE” filed Apr. 7, 2003, which are hereby incorporated herein by reference.

### BRIEF DESCRIPTION OF THE DRAWINGS

The accompanying drawings, which are incorporated in, and constitute a part of this specification illustrate exemplary implementations and embodiments of the invention and, together with the description, serve to explain principles of the invention.

FIG. 1A depicts a typical RGB striped panel display having a standard 1×1 dot inversion scheme.

FIG. 1B depicts a typical RGB striped panel display having a standard 1×2 dot inversion scheme.

FIG. 2 depicts a novel panel display comprising a subpixel repeat grouping that is of even modulo.

FIG. 3 depicts the panel display of FIG. 2 with one possible set of crossover connections to provide a dot inversion scheme that may abate some undesirable visual effects.

FIG. 4 shows one possible embodiment of a crossover as implemented.

FIGS. 5A and 5B show one possible array of bonding pads without a crossover and with a crossover respectively.

FIGS. 6A and 6B show yet another possible array of bonding pads without a crossover and with a crossover respectively.

FIG. 7 depicts columns that might be adversely impacted by the effect of crossovers, if no compensation is applied.

FIG. 8 depicts another solution to some undesirable visual effects on a repeat subgrouping of even modulo, with a change in dot inversion at driver chip boundaries.

### DETAILED DESCRIPTION

Reference will now be made in detail to implementations and embodiments, examples of which are illustrated in the accompanying drawings. Wherever possible, the same reference numbers will be used throughout the drawings to refer to the same or like parts.

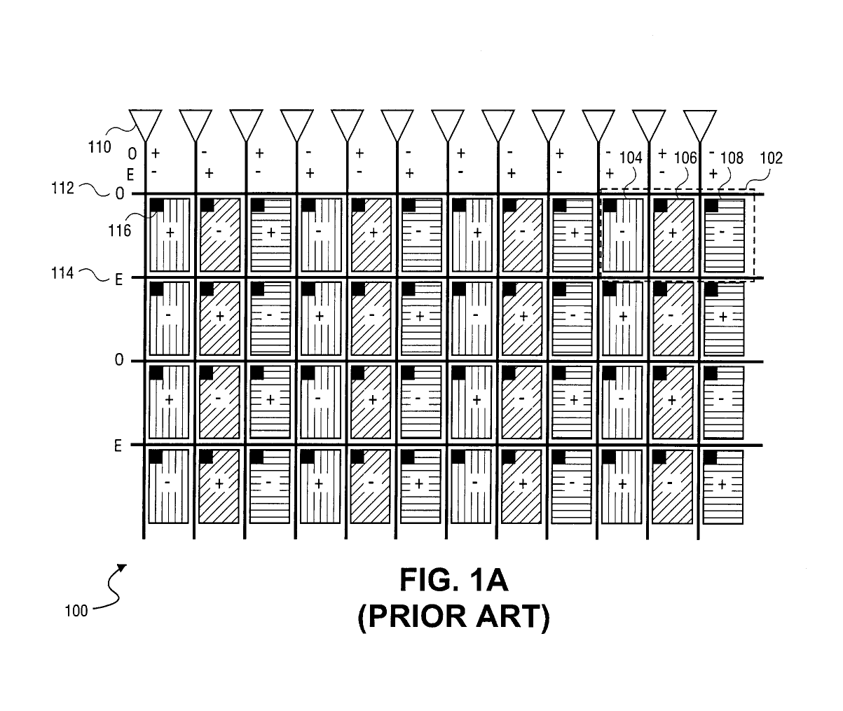

FIG. 1A shows a conventional RGB stripe structure on panel 100 for an Active Matrix Liquid Crystal Display (AMLCD) having thin film transistors (TFTs) 116 to activate individual colored subpixels—red 104, green 106 and blue 108 subpixels respectively. As may be seen, a red, a green and a blue subpixel form a repeating group of subpixels 102 for panel 100.

As also shown, each subpixel is connected to a column line (each driven by a column driver 110) and a row line (e.g. 112 and 114). In the field of AMLCD panels, it is known to drive the panel with a dot inversion scheme to reduce crosstalk and flicker. FIG. 1A depicts one particular dot inversion scheme—i.e. 1×1 dot inversion—that is indicated by a “+” and a “−” polarity given in the center of each subpixel. Each row line is typically connected to a gate (not shown in FIG. 1A) of TFT 116. Image data—delivered via the column lines—are typically connected to the source of each TFT. Image data is written to the panel a row at a time and is given a polarity bias scheme as indicated herein as either ODD (“O”) or EVEN (“E”) schemes. As shown, row 112 is being written with ODD polarity scheme at a given time while row 114 is being written with EVEN polarity scheme at a next time. The polarities alternate ODD and EVEN schemes a row at a time in this 1×1 dot inversion scheme.

FIG. 1B depicts another conventional RGB stripe panel having another dot inversion scheme—i.e. 1×2 dot inversion. Here, the polarity scheme changes over the course of two rows—as opposed to every row, as in 1×1 dot inversion. In both dot inversion schemes, a few observations are noted: (1) in 1×1 dot inversion, every two physically adjacent subpixels (in both the horizontal and vertical direction) are of different polarity; (2) in 1×2 dot inversion, every two physically adjacent subpixels in the horizontal direction are of different polarity; (3) across any given row, each successive colored subpixel has an opposite polarity to its neighbor. Thus, for example, two successive red subpixels along a row will be either (+,−) or (−,+). Of course, in 1×1 dot inversion, two successive red subpixels along a column having opposite polarity; whereas in 1×2 dot inversion, each group of two successive red subpixels will have opposite polarity. This changing of polarity decreases noticeable visual effects that occur with particular images rendered upon an AMLCD panel.

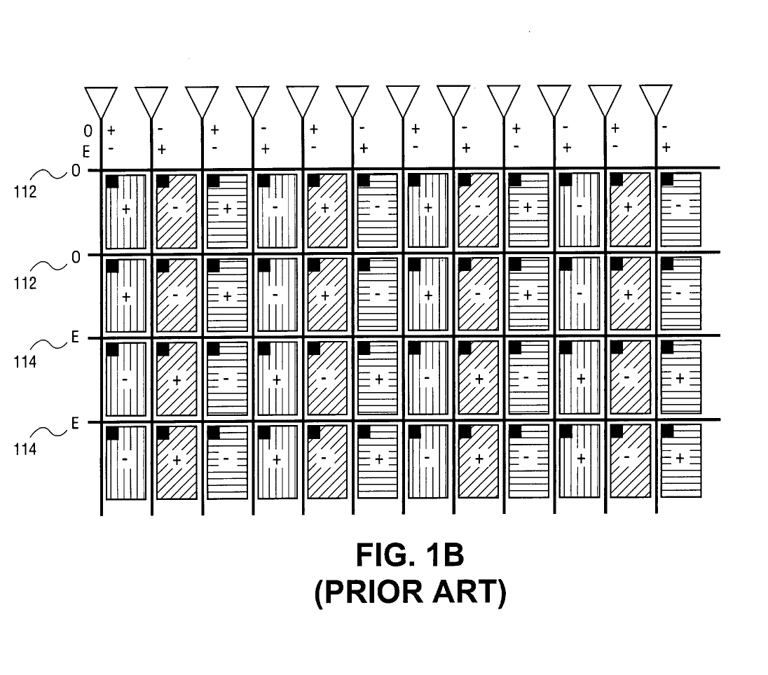

FIG. 2 shows a panel comprising a repeat subpixel grouping 202, as further described in the '353 application. As may be seen, repeat subpixel grouping 202 is an eight subpixel repeat group, comprising a checkerboard of red and blue subpixels 104 and 108, respectively, with two columns of reduced-area green subpixels 106 in between. The following discussion may be applied to other subpixel patterns, such as a checkerboard of red and green with two columns of reduced area blue subpixels in between, without departing from the scope of the present invention. If the standard 1×1 dot inversion scheme is applied to a panel comprising such a repeat grouping (as shown in FIG. 2), then it becomes apparent that the property described above for RGB striped panels (namely, that successive colored pixels in a row and/or column have different polarities) is now violated. This condition may cause a number of visual defects noticed on the panel—particularly when certain image patterns are displayed. This observation also occurs with other novel subpixel repeat grouping—for example, the subpixel repeat grouping in FIG. 1 of the '352 application—and other repeat groupings that are not an odd number of repeating subpixels across a row. Thus, as the traditional RGB striped panels have three such repeating subpixels in its repeat group (namely, R, G and B), these traditional panels do not necessarily violate the above noted conditions. However, the repeat grouping of FIG. 1 in the present application has four (i.e. an even number) of subpixels in its repeat group across a row (e.g. R, G, B, and G). It will be appreciated that the embodiments described herein are equally applicable to all such even modulus repeat groupings (i.e. 2, 4, 6, 8, etc subpixels across a row and/or column)—including the Bayer repeat pattern and all of its variants as well as several other layouts incorporated by reference from the patent applications listed above.

In the co-pending '232 application, there is disclosed various layouts and methods for remapping the TFT backplane so that, although the TFTs of the subpixels may not be regularly positioned with respect to the pixel element itself (e.g. the TFT is not always in the upper left hand corner of the pixel element), a suitable dot inversion scheme may be effected on a panel having an even modulo subpixel repeat grouping. Other possible solutions are possible and disclosed in the co-pending applications noted above.

If it is desired not to re-design the TFT backplane, and if it is also desired to utilize standard column drivers to effect a suitable dot inversion scheme, one possible implementation is to employ crossover connections to the standard column driver lines, as herein described. The first step to a final and suitable implementation is to design a polarity inversion pattern to suit the subpixel repeat grouping in question. For example, for the layout as shown in FIG. 2, the repeat grouping looks like:

R G B G

B G R G

with the R and B subpixels on a checkerboard and G subpixels interspersed between. Although FIG. 2 depicts that the green subpixels are of reduced area as compared to the red and blue subpixels themselves, it will be appreciated that all subpixels may be the same size or that other subpixel dimensioning are possible without departing from the scope of the present invention.

So, with the idea of choosing suitable polarity inversion patterns that would minimize flicker and crosstalk, the following are but a few exemplary embodiments disclosed:

Pattern 1: R+ G+ B+ G− R− G+ B− G− [REPEAT]

Pattern 2: R+ G+ B− G− R− G+ B+ G− [REPEAT]

Pattern 3: R+ G− B+ G+ R− G− B− G+ [REPEAT]

Pattern 4: R+ G− B− G+ R− G− B+ G+ [REPEAT]

First Embodiment of Pattern 1:

(+) 1. R+ G+ B+ G− R− G+ B− G− [REPEAT]

(+) 2. B− G− R− G+ B+ G− R+ G+ [REPEAT]

(−) 3. R− G− B− G+ R+ G− B+ G+ [REPEAT]

(−) 4. B+ G+ R+ G− B− G+ R− G− [REPEAT]

Second Embodiment of Pattern 1:

(+) 1. R+ G+ B+ G− R− G+ B− G− [REPEAT]

(+) 2. B− G− R− G+ B+ G− R+ G+ [REPEAT]

(−) 3. R− G+ B− G− R+ G+ B+ G− [REPEAT]

(−) 4. B+ G− R+ G+ B− G− R− G+ [REPEAT]

Patterns 1 through 4 above exemplify several possible basis patterns upon which several inversion schemes may be realized. A property of each of these patterns is that the polarity applied to each color alternates with each incidence of color.

These and other various patterns can then be implemented upon a panel having that subpixel repeat grouping and that patterns as a template. For example, a first embodiment of pattern 1 is shown above. The first row repeats the polarities of pattern 1 above and then, for the second row, the polarities are inverted. Then, as shown above, applying alternating 2 row inversion, alternating polarities of R and B in their own color planes may be realized. And the Gs alternate every second row. The second embodiment of Pattern 1 shown above, however, allows for alternating Gs every row.

It will be appreciated that other basis patterns may be suitable that alternate every two or more incidences of a colored subpixel and still achieve desirable results. It will also be appreciated that the techniques described herein may be used in combination with the techniques of the other co-pending applications noted above. For example, the patterns and crossovers described herein could be applied to a TFT backplane that has some or all of its TFT located in different locations with respect to the pixel element. Additionally, there may be reasons when designing the driver to alternate less frequently than every incidence (e.g., G less often than R and/or B) in order to reduce driver complexity or cost.

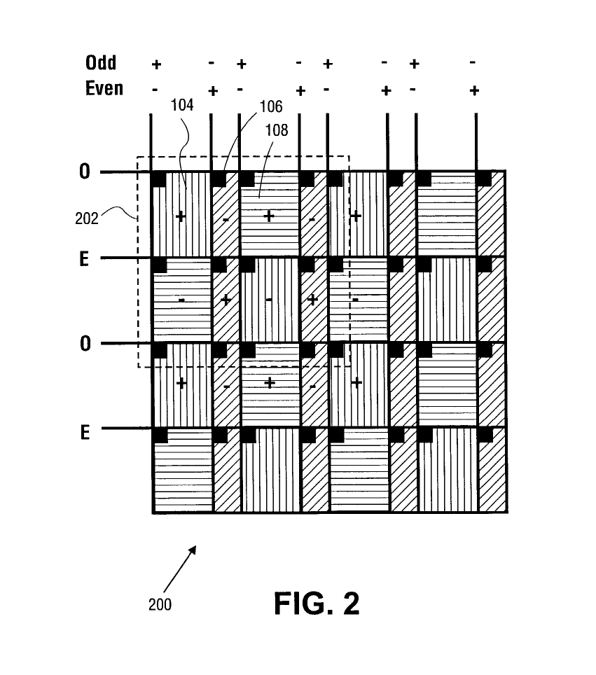

Patterns, such as the ones above, may be implemented at various stages in the system. For example, the driver could be changed to implement the pattern directly. Alternatively, the connections on the panel glass could be rerouted. For example, FIG. 3 is one embodiment of a set of crossover connections that implements Pattern 2 above in a panel 300. Crossovers 302 are added to interchange the column data on columns 2 and 3, 5 and 6, etc. Thus, two crossovers are added in this embodiment per every 8 columns. For a UXGA (1600×1200) panel, this might add approximately 800 crossovers to the column driver set. Other patterns may be implemented with different sets of crossovers without departing from the scope of the present invention.

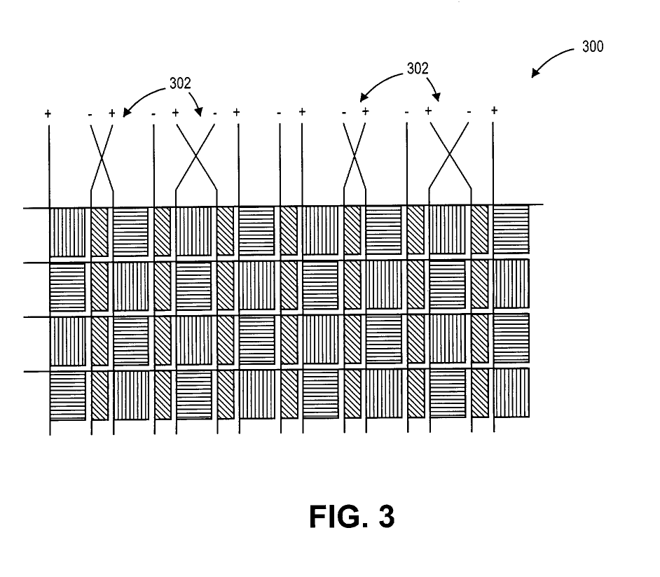

To implement the crossovers, a simple process can be used that utilizes existing processing steps for TFTs. FIG. 4 shows a typical crossover. Driver pads 402 are connected to driver lines 404 which extend down as a column line to intersect with gate lines 408 and send data through TFT 410. Where the drivers are meant to crossover, an insulator layer (406) may be placed so as to prevent shorts and other problems. Driver lines 404 and insulator layer 406 can be fabricated using standard LCD fabrication techniques.

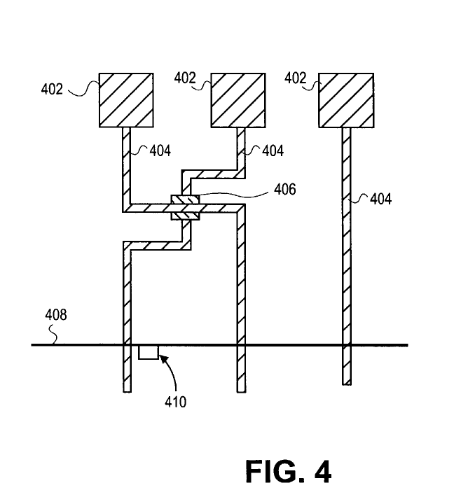

Another embodiment of a crossover is shown in FIGS. 5A and 5B. FIG. 5A shows an array of bonding pads 502. Each pad has a given polarity—the output of which is shown at the bottom of the driver lines 504. For a spacing on the column electrodes of 80 um, the bonding pads shown in FIGS. 5A and 5B are approximately 80 um square with a 80 um space. With such a spacing, it is possible to form crossover 506 as shown in FIG. 5B. As may be seen, this “swap” may be accomplished by rerouting the traces on the glass or the TAB chip carrier as shown.

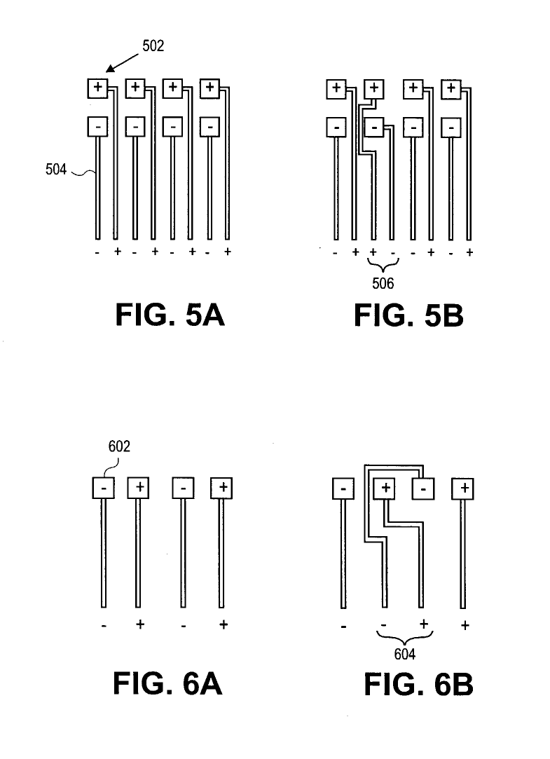

FIGS. 6A and 6B show yet another embodiment of crossover connections to implement polarity patterns as described above. FIG. 6A depicts the bonding pads 602 as another array of such pads—each pad effecting a polarity on the column lines 604, the polarity of which is shown at the bottom of each such line. FIG. 6B shows how a crossover 604 could be effected with such a pad structure. As alternative embodiments, the bonding pads could be for chip on glass COG or for inner lead or outer lead bonds on a tape chip carrier. In such a case, with 80 um column spacing, the bonding pads are now 40 um with 40 um space—i.e. with enough room to route the leads as shown.

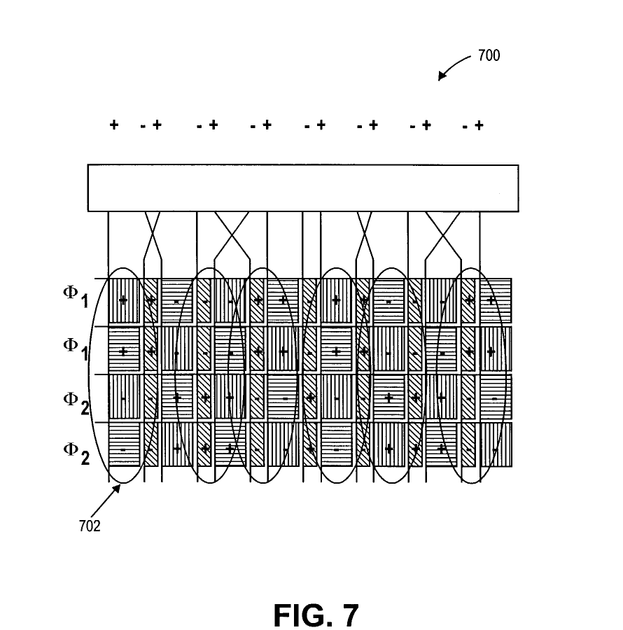

One possible drawback to the crossovers is a potential visual effect wherein every crossover location may have a visually darker or lighter column—if this effect is not compensated. FIG. 7 shows one embodiment of a panel 700 having crossovers. On the columns that have crossovers, such as column 702 and other columns as circled, these columns may be slightly darker or lighter than the other columns. This effect is caused by coupling capacitance between the source (data) lines and the pixel electrodes. Normally, each source line is the opposite polarity so the coupling of extraneous voltages is canceled on the pixel electrode. If the source lines are the same polarity, then the pixel voltage will be reduced and the pixel column will appear darker or lighter. This effect is generally independent of the data voltages and can be compensated by a correction signal added to the voltage of the dark or light column. Furthermore, this visual effect can occur when horizontally adjacent pixels have the same polarity. The mechanism for the darkening or lightening is the parasitic capacitance between the data line to the pixel electrode. When the two adjacent data lines, one on the right of the affected pixel and one on the left of the affected pixel, are of opposite polarity, the effect of the parasitic coupling from each data line tends to cancel each other. However, when the polarities of each data line are the same, they will not cancel each other, and there will be a net bias applied to the pixel electrode. This net bias will have the effect or lowering the magnitude of the pixel electrode voltage. For normally black LCD panels, the effect will be to darken the pixel. For normally white LCD panels, the effect will be to lighten the pixel.

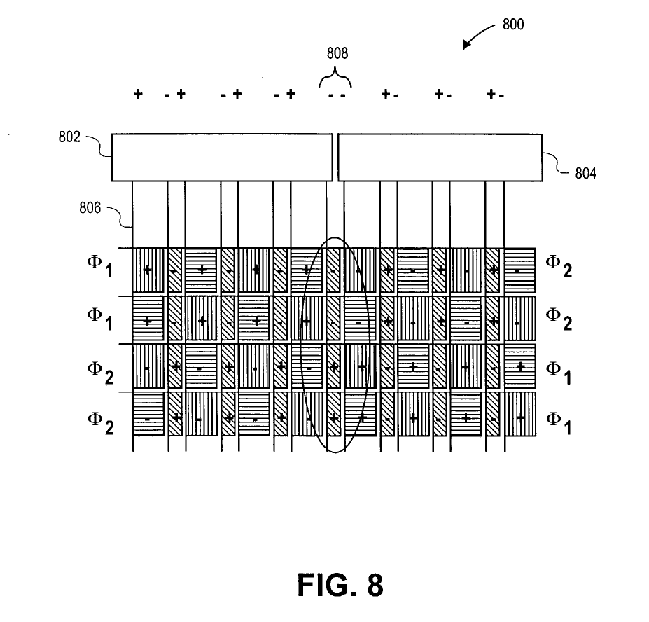

This same darker or lighter column effect occurs in another possible solution to the problem of image degradation or shadowing if same colored pixels have the same polarity along a row for an extended area on the screen. FIG. 8 shows a panel 800 having the same subpixel repeating subgrouping as FIG. 2. Standard driver chips 802 and 804 are used to drive the column lines 806—and effecting a 1×2 dot inversion scheme as shown. Although same color subpixels across a row under one such chip (say 802) and might cause some shadowing, this visual effect is somewhat abated by reversing the inversion scheme at the chip boundary 808. It may now be seen that the same colored subpixels under chip 804 will have different polarities as those under chip 802 which abates the shadowing. However, the column at the chip boundary 808 will be darker or lighter than the other columns—unless compensated.

In order to correct or otherwise compensate for the darker or lighter columns that occur as described herein, a predetermined voltage can be added to the data voltage on the darker or lighter columns so as to compensate for the dark or light column. This correction voltage is independent of the data voltage so can be added as a fixed amount to all darker or lighter columns. This correction value can be stored in a ROM incorporated in the driver electronics.

A second compensation method is the look forward compensation method. In this method, each of the data values of the pixels connected to data lines adjacent to the affect pixel are examined for the subsequent frame. From these values, an average compensation value can be calculated and applied to the affected pixel. The compensation value can be derived to a precision suitable to the application. This method requires a frame buffer to store the next frame worth of data. From this stored data, the compensation value would be derived.

A third method is the look back method. Under the assumption that the frame to frame difference in the compensation value is negligible, the data from the previous frame's data may be used to calculation the compensation value for the affected pixel. This method will generally provide a more accurate compensation value than the first method without requiring the frame buffer described in the second method. The third method may have the greatest error under some specific scene changes. By detecting the occurrence of those scene changes, the look back compensation may be turned off, and alternate method, such as no compensation or either of the compensation methods described above, may be applied for that circumstance.

For the above implementations and embodiments, it is not necessary that crossover connections or polarity inversions be placed for every occurrence of a subpixel repeating group. Indeed, while it might be desirable to have no two incidence of a same-colored subpixel having the same polarity, the visual effect and performance of the panel, from a user's standpoint, might be well enough to abate any undesirable visual effects by allowing some two or more incidences of same-colored subpixels (in either a row or column direction) to have the same polarity. Thus, it suffices for the purposes of the present invention that there could be fewer crossover connections or polarity inversions to achieve a reasonable abatement of bad effects. Any fewer number of crossovers or polarity inversions could be determined empirically or heuristically and noting the visual effects to achieve satisfactory performance from a user's standpoint.

What is claimed is:

1. A liquid crystal display comprising:
a panel substantially comprising a subpixel repeating group, the group having an even number of subpixels across a first direction;
a driver circuit coupled to the panel providing image data signals to the panel, the signals effecting substantially a dot inversion scheme to the panel; and
a plurality of crossover connections from the driver circuit to the columns of the panel such that same color subpixels across the first direction such that the polarities of the same color subpixels substantially alternate.

2. The liquid crystal display of claim 1, wherein the first direction is along a row of subpixels of the panel.

3. The liquid crystal display of claim 1, wherein the first direction is along a column of subpixels of the panel.

4. The liquid crystal display of claim 1, wherein the subpixel repeating group comprises a Bayer pattern of subpixels.

5. The liquid crystal display of claim 1, wherein the subpixel repeating group comprises a sequence of red (R) green (G) blue (B) green (G) colored subpixels along a row direction.

6. The liquid crystal display of claim 1, wherein the dot inversion scheme is a 1×1 dot inversion scheme.

7. The liquid crystal display of claim 1, wherein the dot inversion scheme is 1×2 dot inversion scheme.

8. The liquid crystal display of claim 1, wherein the crossover connections effect a change in polarity of same colored subpixels along the first direction with a frequency such that undesirable visual effects are abated.

9. The liquid crystal display of claim 8, wherein the frequency of polarity changes is every two incidences of same colored subpixels.

10. The liquid crystal display of claim 8, wherein the frequency of polarity changes is greater than every two incidences of same colored subpixels.

11. A method for effecting a dot inversion scheme upon subpixels of a liquid crystal display, the display substantially comprising a subpixel repeat grouping of even number along a first direction, the method comprising:
determining a repeating grouping of subpixels of even number along a first direction;
assigning a polarity to each subpixel along one or more repeating groupings such that same colored subpixels along the first direction substantially alternate polarity; and
providing crossover connections to effect the assigned polarities.

12. The method of claim 11, wherein providing crossover connections further comprises:
providing crossover connections with a frequency of polarity changes to abate undesirable visual effects.

13. The method of claim 12, wherein the frequency of polarity changes is every two incidences of same colored subpixels.

14. The method of claim 12, wherein the frequency of polarity changes is greater than every two incidences of same colored subpixels.

15. A liquid crystal display comprising:
a panel having substantially a subpixel repeating group, the group having an even number of subpixels across a first direction;
at least two driver lines providing crossover driving signals to columns of the panel such that same color subpixels across the first direction have substantially alternating polarities.

16. The liquid crystal display of claim 15, further comprising:
at least one insulator layer in between the at least two driver lines at a crossover location for the at least two driver lines.

17. The liquid crystal display of claim 15, wherein the driving signals from the at least two driver lines effect substantially a dot inversion scheme to the panel.

18. The liquid crystal display of claim 15, further comprising:
a plurality of driving pads for each driving line, each driving pad having a given polarity and capable of providing a crossover driving signal.

19. A liquid crystal display comprising:
a panel substantially comprising a subpixel repeating group, the group having an even number of subpixels across a first direction;
a driver circuit coupled to the panel providing image data signals to the panel, the signals effecting substantially a dot inversion scheme to the panel; and
a plurality of crossover connections from the driver circuit to the columns of the panel such that same color subpixels across the first direction such that the polarities of the same color subpixels substantially alternate, and wherein the inversion scheme is reversed at portions of the panel.

20. The liquid crystal display of claim 19, wherein the driver circuit selectively applies a predetermined voltage on columns exhibiting dark or light colors.

21. The liquid crystal display of claim 19, wherein a fixed voltage value is selectively applied to at least subpixel of the group, the subpixel affected with an undesirable characteristic.

22. The liquid crystal display of claim 21, wherein an average voltage value is selectively applied to the affected subpixel based on voltage values of surrounding subpixels.

23. The liquid crystal display of claim 21, wherein a compensation voltage value is selectiveluy applied to the affected subpixel based on previous frame subpixel voltage values.

24 A method for effecting a dot inversion scheme upon subpixels of a liquid crystal display, the display substantially comprising a subpixel repeat grouping of even number along a first direction, the method comprising:
applying polarities to each subpixel along one or more repeating groupings such that same colored subpixels along the first direction substantially alternate polarity using crossover connections.

25. The method of claim 24, further comprising:
providing crossover connections with a frequency of polarity changes to abate undesirable visual effects.

26. The method of claim 25, wherien the frequency of polarity changes is every two incidences of same colored subpixels.

27. The method of claim 25, wherein the frequency of polarity changes is greater than every two incidences of same colored subpixels.

28. The method of claim 24, further comprising:
selectively applying a predetermined voltage on columns of the subpixel repeating groupings exhibiting dark or light colors.

29. The method of claim 24, further comprising:
selectively applying a fixed voltage value to at least one subpixel of a grouping, the subpixel affected with an undesirable characteristic.

30. The method of claim 29, further comprising:
selectively applying an average voltage value to the affected subpixel based on voltage values of surrounding subpixels.

31. The method of claim 29, further comprising:
selectively applying a compensation voltage value to the affected subpixel based on previous frame subpixel voltage values.
